(19) United States
(12) Patent Application Publication
(10) Pub. No.: US 2024/0349808 A1
(43) Pub. Date: Oct. 24, 2024

(54) HEATING ELEMENT AND AEROSOL GENERATION DEVICE

(71) Applicant: Jiangmen Smoore New Material Co., Ltd., Jiangmen (CN)

(72) Inventors: Boping YANG, Jiangmen (CN); Yaqiao WANG, Jiangmen (CN)

(21) Appl. No.: 18/756,660

(22) Filed: Jun. 27, 2024

Related U.S. Application Data
(63) Continuation of application No. PCT/CN2022/092545, filed on May 12, 2022.

(30) Foreign Application Priority Data
Dec. 31, 2021 (CN) 202111678042.7
Dec. 31, 2021 (CN) 202123425671.7

(51) Int. Cl. A24F 40/465; D02G 3/44

(52) U.S. Cl. CPC A24F 40/465; D02G 3/44

(57) ABSTRACT

A heating element for heating and atomizing an aerosol generation substrate includes: a support tube; and a conduction layer arranged on an outer side of the support tube and in communication with the support tube, the conduction layer having an integrally braided structure. In an embodiment, a thickness of the conduction layer is greater than or equal to 0.1 mm and less than or equal to 3 mm.

### CROSS-REFERENCE TO PRIOR APPLICATION

This application is a continuation of International Patent Application No. PCT/CN2022/092545, filed on May 12, 2022, which claims priority to Chinese Patent Application No. 202111678042.7, filed on Dec. 31, 2021, and Chinese Patent Application No. 202123425671.7, also filed on Dec. 31, 2021. The entire disclosure of both applications is hereby incorporated by reference herein.

### FIELD

Embodiments of this application relate to the field of electronic atomization technologies, and specifically, to a heating element and an aerosol generation device.

### BACKGROUND

Currently, a central tube cotton core heating element used for an atomizer is a novel atomization heating element, and has a higher atomization amount compared with conventional cotton rope heating elements and cotton wrapped heating elements.

The basic structure of the central tube cotton core heating element includes three parts: a central support tube, a sleeve-shaped cotton layer, and a resistance wire. The sleeve-shaped cotton layer is connected to an aerosol generation substrate in the central support tube and the resistance wire, and the aerosol generation substrate is heated and atomized by the resistance wire on a surface of the sleeve-shaped cotton layer. However, the form, the density, the surface, and the material of the sleeve-shaped cotton layer have a significant impact on the atomization process and the generated aerosol, and their differences directly cause taste changes of a finished product of the atomizer.

There are two forms of sleeve-shaped cotton layers, where one is a fabric wrapped cotton layer, and the other is a ring-shaped sponge cotton layer. The fabric wrapped cotton layer has a fabric tip in its atomization region, and the cotton layer at the tip is irregularly shaped and is significantly different from the remaining region in form. As a result, the atomization state is uncontrollable.

For the ring-shaped sponge cotton layer, a part of the cotton layer around which the heating wire is wound is severely compressed because of large compressibility of sponge, and is greatly different from a part around which the heating wire is not wound in thickness. As a result, the consistency of the cotton layer is poor.

### SUMMARY

In an embodiment, the present invention provides a heating element for heating and atomizing an aerosol generation substrate, comprising: a support tube; and a conduction layer arranged on an outer side of the support tube and in communication with the support tube, the conduction layer comprising an integrally braided structure.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of a heating element according to an embodiment of this application;

FIG. 2 is a schematic structural diagram 1 of a conduction layer according to an embodiment of this application;

FIG. 3 is a schematic structural diagram of a heating wire according to an embodiment of this application;

FIG. 4 is a schematic structural diagram of a support tube according to an embodiment of this application;

FIG. 5 is a schematic structural diagram 2 of a conduction layer according to an embodiment of this application;

FIG. 6 is a schematic structural diagram 3 of a conduction layer according to an embodiment of this application;

FIG. 7 is a schematic structural diagram 4 of a conduction layer according to an embodiment of this application;

FIG. 8 is a schematic structural diagram of an aerosol generation device according to an embodiment of this application; and

FIG. 9 is a schematic structural diagram of an accommodating cavity according to an embodiment of this application.

### DETAILED DESCRIPTION

In an embodiment, the present invention provides a heating element.

A second aspect of the embodiments of this application provides an aerosol generation device.

In view of this, according to the first aspect of the embodiments of this application, a heating element is provided, where the heating element is used for heating and atomizing an aerosol generation substrate, and the heating element includes: a support tube; and a conduction layer, arranged on an outer side of the support tube and in communication with the support tube, where the conduction layer is of an integrally braided structure.

The heating element provided in the embodiments of this application includes the support tube and the conduction layer. Specifically, the conduction layer is arranged on the outer side of the support tube, and the conduction layer is in communication with the support tube. It can be understood that the aerosol generation substrate is fed into the support tube, and because the conduction layer is in communication with the support tube, the aerosol generation substrate is enabled to flow toward the conduction layer, and a heating wire of the heating element heats and atomizes the aerosol generation substrate flowing toward the conduction layer, to generate an aerosol. The aerosol generation substrate is a liquid aerosol generation substrate.

Further, the conduction layer is of an integrally braided structure. That is to say, the conduction layer is manufactured into a braided structure by a conduction substrate with a braiding method, thereby enabling the conduction layer to have very good integrity and consistency. Compared with the related technologies in which the conduction layer is a fabric wrapped cotton layer, consistency between forms in positions on the conduction layer can be ensured, thereby ensuring that an atomization state of an aerosol generation device with the heating element is controllable. In addition, compared with the related technologies in which the conduction layer is a ring-shaped sponge cotton layer, the conduction layer formed with the braiding method has small compressibility, so that a part of the conduction layer around which the heating wire is wound is slightly different from a part around which the heating wire is not wound in thickness, and the conduction layer has very good consistency, to ensure the taste of the aerosol generation device.

In addition, the conduction layer is arranged into an integrally braided structure, that is, the conduction layer is formed by using a braiding method on the outer side of the support tube, the conduction layer and the support tube can further closely fit each other, thereby ensuring that a gap between the conduction layer and the support tube is controllable, to facilitate scaling, and liquid leakage can be further prevented.

In actual application, yarn may be braided to form the conduction layer by using a braiding machine. To be specific, the conduction layer is a cotton layer, that is, the heating element is a cotton core heating element, so that the aerosol generation device can have a higher atomization amount while ensuring that the cotton layer has very good integrity and consistency.

It is worth noting that the heating element further includes a heating wire, and the heating wire is spirally wound around the outer side of the conduction layer. After the support tube is wrapped in the conduction layer by using the braiding machine, the heating wire may be wound around the outer side of the conduction layer by using a winding machine, and therefore consistency between positions on the conduction layer can be further ensured. Specifically, in each of the related technologies, when the heating wire is wound, manual mounting is used. Consequently, assembly between the heating wire and the conduction layer has poor consistency, and assembly efficiency is low. The winding the heating wire around the outer side of the conduction layer through the winding machine can effectively overcome the problem of poor consistency caused because of manually mounting the heating wire, and improve product assembly efficiency, so that tastes of different aerosol generation devices have very good consistency.

In specific application, the braiding texture of the integrally braided structure may be set according to actual needs.

It should be noted that the material for braiding the conduction layer may be a fiber material such as cotton thread, cotton yarn, flax, viscose, polyester, or polyimide, and may be specifically set according to actual needs. It can be understood that the performing braiding with the cotton thread or the cotton yarn to form the conduction layer can increase the atomization amount of the aerosol generation device while enabling the conduction layer to have very good integrity and consistency.

In addition, the heating element provided according to the foregoing technical solution of this application further has the following additional technical features:

In a possible design, the thickness d of the conduction layer satisfies 0.1 mm≤d≤3 mm.

In this design, the thickness d of the conduction layer is limited to satisfying 0.1 mm≤d≤3 mm. It can be understood that the thickness of the conduction layer should not be excessively large, and if the thickness of the conduction layer is excessively large, circulation of the aerosol generation substrate is not facilitated. In addition, the compressibility of the conduction layer is further improved. When the heating wire is wound, consistency between positions on the conduction layer is prone to be poor. In addition, the thickness of the conduction layer should not be excessively small, and if the thickness of the conduction layer is excessively small, the atomization amount of the aerosol generation device is affected. The limiting the thickness of the conduction layer to ranging from 0.1 mm to 3 mm can ensure the atomization amount of the aerosol generation device while enabling positions on the conduction layer to have very good consistency.

In a possible design, the conduction layer includes cotton thread or cotton yarn, and the conduction layer is formed into the integrally braided structure by the cotton thread or the cotton yarn with a braiding method.

In this design, the conduction layer is limited to including cotton thread or cotton yarn. That is to say, cotton thread is used for preparing the conduction layer using the braiding method, thereby forming the conduction layer into the integrally braided structure. To be specific, the conduction layer is a cotton layer, that is, the heating element is a cotton core heating element, thereby increasing the atomization amount of the aerosol generation device while ensuring that the cotton layer has very good integrity and consistency.

In addition, cotton yarn may alternatively be used for preparing the conduction layer using the braiding method, so that the obtained conduction layer is formed into the integrally braided structure, and may be specifically set according to actual needs.

In actual application, cotton thread or cotton yarn may be braided using the braiding machine to wrap the outer side of the support tube. It can be understood that the density and the thickness of the conduction layer may be controlled by adjusting the braiding speed of the braiding machine. Specifically, the braiding texture may be diagonal texture, cross texture, or herringbone texture, and may be specifically set according to actual needs.

In a possible design, the cotton thread or the cotton yarn includes 8 strands to 64 strands of yarn.

In this design, the cotton thread or the cotton yarn is limited to including 8 strands to 64 strands of yarn. That is to say, 8 strands to 64 strands of yarn are braided using the braiding machine to form the conduction layer, thereby forming the conduction layer into the integrally braided structure. To be specific, the conduction layer is a cotton layer, that is, the heating element is a cotton core heating element, thereby increasing the atomization amount of the aerosol generation device while ensuring that the cotton layer has very good integrity and consistency.

In addition, that the cotton thread or the cotton yarn includes 8 strands to 64 strands of yarn can ensure that the conduction layer formed through braiding has specified thickness and circulation performance.

In actual application, the yarn may be a single strand of yarn, or be formed by merging 2 strands to 8 strands of second-level yarn, and may be specifically set according to actual needs.

In a possible design, the yarn is a single strand of first-level yarn; or the yarn includes 2 strands to 8 strands of second-level yarn.

In this design, the yarn may be limited to being a single strand of first-level yarn, that is, 8 strands to 64 strands of first-level yarn are braided using the braiding machine to form the conduction layer, thereby forming the conduction layer into the integrally braided structure. Alternatively, the yarn may be formed by merging 2 strands to 8 strands of second-level yarn, and then 8 strands to 64 strands of second-level yarn formed through merging are braided using the braiding machine to form the conduction layer, thereby forming the conduction layer into the integrally braided structure, thereby increasing the atomization amount of the aerosol generation device while ensuring that the cotton layer has very good integrity and consistency.

In actual application, the material of the yarn may be twist yarn or twistless yarn made of filament or staple, and may be specifically set according to actual needs.

In a possible design, the diameter D of the yarn satisfies 0.05 mm≤D≤2 mm.

In this design, the value range of the diameter D of the yarn is limited. To be specific, the value range of the diameter of each strand of first-level yarn or each strand of merged second-level yarn is limited. It can be understood that if the diameter of the yarn is excessively small, the conduction layer formed through braiding has low structural strength, and the service life of the heating element is shortened. If the diameter of the yarn is excessively large, the conduction layer formed through braiding is prone to be excessively thick, which is adverse to the circulation of the aerosol generation substrate and affects the atomization amount of the aerosol generation device. The limiting the diameter of the yarn to ranging from 0.05 mm to 2 mm can increase the atomization amount of the aerosol generation device while ensuring that the conduction layer has specific structural strength.

In a possible design, the fineness S of the yarn satisfies 10≤S≤60.

In this design, it can be understood that the larger fineness of the yarn indicates the smaller diameter of the yarn, and the further limiting the value range of the fineness of the yarn can further increase the atomization amount of the aerosol generation device while ensuring that the conduction layer has specific structural strength.

In a possible design, the heating element further includes a heating wire. The heating wire is wound around an outer side of the conduction layer, and the heating wire includes a plurality of winding portions, where a spacing is provided between the plurality of winding portions and the conduction layer; or the plurality of winding portions are in contact with the conduction layer.

In this design, the heating element is limited to further including a heating wire. Specifically, the heating wire is wound around an outer side of the conduction layer. Specifically, the heating wire is spirally wound around the outer side of the conduction layer, so that when the heating wire is electrified to generate heat, the aerosol generation substrate flowing toward the conduction layer can be heated and atomized, to generate an aerosol.

Further, the heating wire includes a plurality of winding portions, where a spacing is provided between the plurality of winding portions and the conduction layer, or the plurality of winding portions are in contact with the conduction layer. That is to say, when the heating wire is wound around the outer side of the conduction layer, the conduction layer may not be compressed, so that a part of the conduction layer around which the heating wire is wound is consistent with a part around which the heating wire is not wound in thickness, thereby further ensuring consistency of the conduction layer, and then ensuring that the atomization state of the aerosol generation device is controllable.

In actual application, the heating wire may be wound around the outer side of the conduction layer using the winding machine, thereby further ensuring consistency between positions on the conduction layer. Specifically, in each of the related technologies, when the heating wire is wound, manual mounting is used. Consequently, assembly between the heating wire and the conduction layer has poor consistency, and assembly efficiency is low. The winding the heating wire around the outer side of the conduction layer through the winding machine can effectively overcome the problem of poor consistency caused because of manually mounting the heating wire, and improve product assembly efficiency, so that tastes of different aerosol generation devices have very good consistency.

In a possible design, the support tube includes a body and a plurality of through-holes, where the body is provided with a conduction cavity, the plurality of through-holes are arranged on the body, and the plurality of through-holes are in communication with the conduction cavity and the conduction layer.

In this design, the support tube is limited to including a body and a plurality of through-holes. Specifically, the body is provided with a conduction cavity, it can be understood that the aerosol generation substrate can be fed into the conduction cavity and flow toward the conduction layer through the plurality of through-holes on the body, and a heating wire of the heating element heats and atomizes the aerosol generation substrate flowing toward the conduction layer, to generate an aerosol.

In actual application, the material of the support tube includes one of a metal material, a ceramic material, glass, or engineering plastic, thereby ensuring the structural strength of the support tube, and therefore the conduction layer can be effectively supported.

It is worth noting that the through-hole may be a circular hole or an elliptical hole, and may be specifically set according to actual needs. In addition, the quantity of through-holes may also be set according to actual needs or the specific size of the aerosol generation device.

In a possible design, the inner diameter a of the body satisfies 0.3 mm≤a≤3 mm.

In this design, the value range of the inner diameter of the body is limited, that is, the value range of the width of the conduction cavity is limited. It can be understood that if the inner diameter of the body is excessively small, that is, the width of the conduction cavity is excessively small, the amount of the aerosol generation substrate fed per unit volume is small, and the atomization amount of the aerosol generation device is reduced. If the inner diameter of the body is excessively large, the volume of the heating element is large, which occupies the internal space of the aerosol generation device in an aspect and further causes the volume of the aerosol generation device to be large in another aspect and is adverse to the aesthetics of the product. The limiting the inner diameter of the body to ranging from 0.3 mm to 3 mm can improve the aesthetics of the product while ensuring the atomization amount of the aerosol generation device.

In a possible design, the axial length b of the body satisfies 3 mm≤b≤30 mm.

In this design, the value range of the axial length of the body is limited. Specifically, the axial length b of the body satisfies 3 mm≤b≤30 mm. The value range can improve the aesthetics of the product while ensuring the atomization amount of the aerosol generation device, and may be specifically set according to the size of the product of the aerosol generation device.

In a possible design, the hole diameter n of the through-hole satisfies 0.01 mm≤n≤3 mm.

In this design, the value range of the hole diameter of the through-hole is limited. Specifically, the hole diameter n of the through-hole satisfies 0.01 mm≤n≤3 mm. It can be understood that if the hole diameter of the through-hole is excessively small, the circulation of the aerosol generation substrate is not facilitated, and the atomization amount of the aerosol generation device is reduced. If the hole diameter of the through-hole is excessively large, the structural strength of the support tube is reduced, and therefore the service life of the heating element is shortened. The limiting the hole diameter of the through-hole to ranging from 0.01 mm to 3 mm can prolong the service life of the heating element while ensuring the atomization amount of the aerosol generation device.

In actual application, the conduction layer includes a plurality of capillary holes, and the hole diameter of the through-hole is less than the inner diameter of the body and greater than the diameter of the capillary hole of the conduction layer, thereby ensuring effective circulation of the aerosol generation substrate, and then ensuring the atomization amount of the aerosol generation device.

In a possible design, the material of the support tube includes one of a metal material, a ceramic material, glass, or engineering plastic.

In this design, the material of the support tube is limited to including one of a metal material, a ceramic material, glass, or engineering plastic, thereby ensuring the structural strength of the support tube, and therefore the conduction layer can be effectively supported.

According to a second aspect of this application, an aerosol generation device is provided. The aerosol generation device includes the heating element provided in any one of the foregoing technical solutions, and therefore has all beneficial technical effects of the heating element. Details are not described herein again.

In addition, the aerosol generation device provided according to the foregoing technical solution of this application further has the following additional technical features:

In a possible design, the aerosol generation device further includes an accommodating cavity, an aerosol generation substrate, and a power supply device. The aerosol generation substrate is located in the accommodating cavity, and the power supply device is connected to the accommodating cavity and electrically connected to a heating wire of the heating element.

In this design, the aerosol generation device is limited to further including an accommodating cavity, an aerosol generation substrate, and a power supply device. Specifically, the accommodating cavity is used for accommodating the aerosol generation substrate, and the aerosol generation substrate can be fed into a support tube and flow toward a conduction layer through a plurality of through-holes on the support tube. The power supply device supplies power for the heating wire, so that the heating wire generates heat, and the heat generated by the heating wire can heat and atomize the aerosol generation substrate, to generate an aerosol. The aerosol generation substrate is a liquid aerosol generation substrate.

Further, the conduction layer is of an integrally braided structure. That is to say, the conduction layer is manufactured into a braided structure by a conduction substrate with a braiding method, thereby enabling the conduction layer to have very good integrity and consistency. Compared with the related technologies in which the conduction layer is a fabric wrapped cotton layer, consistency between forms in positions on the conduction layer can be ensured, thereby ensuring that an atomization state of an aerosol generation device with the heating element is controllable. In addition, compared with the related technologies in which the conduction layer is a ring-shaped sponge cotton layer, the conduction layer formed with the braiding method has small compressibility, so that a part of the conduction layer around which the heating wire is wound is slightly different from a part around which the heating wire is not wound in thickness, and the conduction layer has very good consistency, to ensure the taste of the aerosol generation device.

Additional aspects and advantages of this application will be given in part in the following descriptions, become apparent in part from the following descriptions, or be learned from the practice of this application.

A correspondence between reference numerals in FIG. 1 to FIG. 9 and component names is:
100 heating element, 110 support tube, 111 body, 112 through-hole, 120 conduction layer, 130 heating wire, 200 aerosol generation device, 210 accommodating cavity, 211 housing, 212 atomization base, 213 liquid storage cavity, 214 air outlet channel, 215 inhalation opening, 216 holding cavity, 217 sealing member, 218 receiving cavity, 219 liquid flowing channel, 220 air inlet, 221 air inlet channel, and 230 power supply device.

In order to more clearly understand the above objects, features and advantages of this application, this application will be further described in detail below with reference to the drawings and embodiments. It should be noted that the embodiments in this application and features in the embodiments may be mutually combined in case that no conflict occurs.

In the following description, many specific details are provided to give a full understanding of this application. However, this application may alternatively be implemented in other manners different from those described herein. Therefore, the protection scope of this application is not limited to the specific embodiments disclosed below.

A heating element 100 and an aerosol generation device 200 provided according to some embodiments of this application are described below with reference to FIG. 1 to FIG. 9.

### Embodiment 1

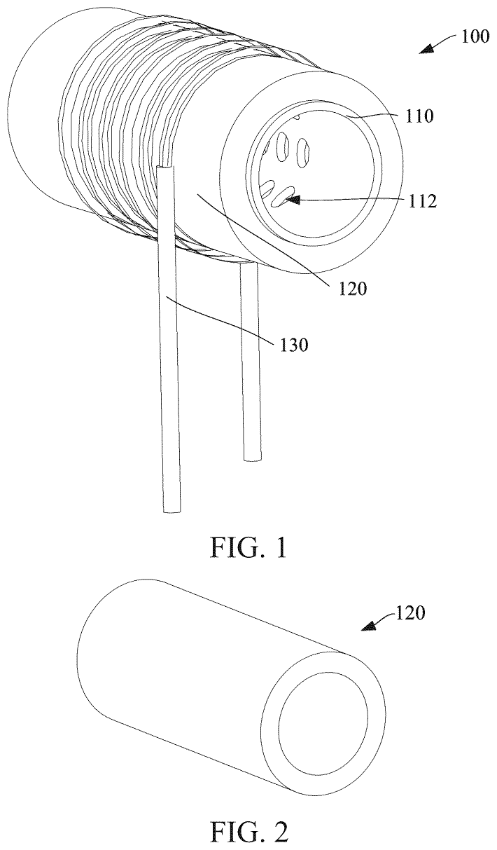

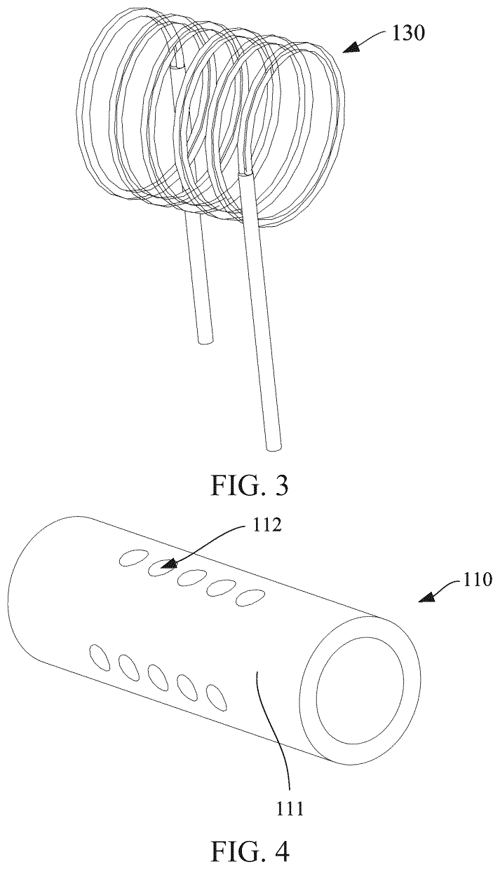

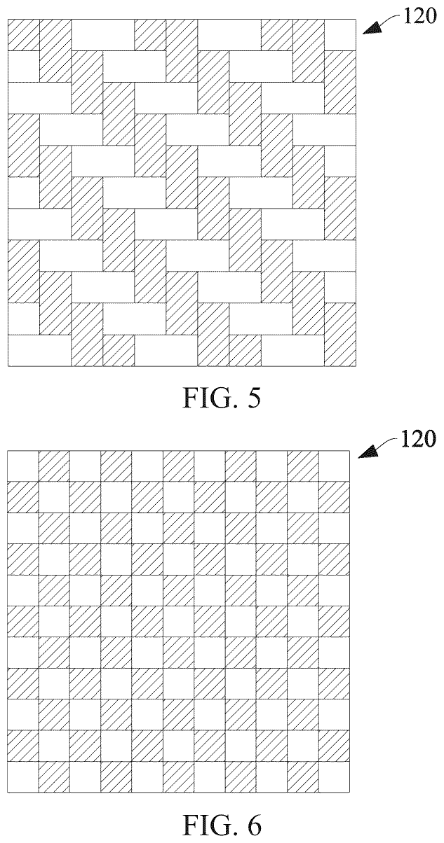

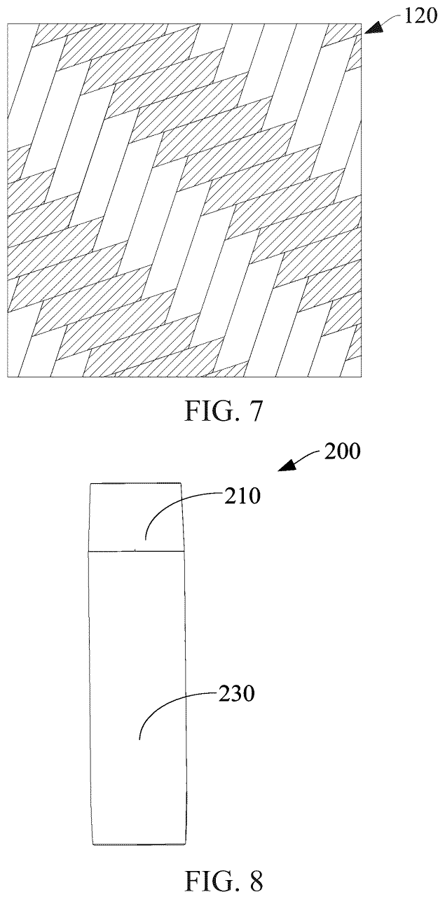

As shown in FIG. 1, FIG. 2, FIG. 5, FIG. 6, and FIG. 7, An embodiment of a first aspect of this application provides a heating element 100. The heating element 100 is used for heating and atomizing an aerosol generation substrate, and the heating element 100 includes: a support tube 110; and a conduction layer 120, arranged on an outer side of the support tube 110 and in communication with the support tube 110, where the conduction layer 120 is of an integrally braided structure.

The heating element 100 provided in this embodiment of this application includes the support tube 110 and the conduction layer 120. Specifically, the conduction layer 120 is arranged on the outer side of the support tube 110, and the conduction layer 120 is in communication with the support tube 110. It can be understood that the aerosol generation substrate is fed into the support tube 110, and because the conduction layer 120 is in communication with the support tube 110, the aerosol generation substrate is enabled to flow toward the conduction layer 120, and a heating wire 130 of the heating element 100 heats and atomizes the aerosol generation substrate flowing toward the conduction layer 120, to generate an aerosol. The aerosol generation substrate is a liquid aerosol generation substrate.

Further, the conduction layer 120 is of an integrally braided structure. That is to say, the conduction layer 120 is manufactured into a braided structure by a conduction substrate with a braiding method, thereby enabling the conduction layer 120 to have very good integrity and consistency. Compared with the related technologies in which the conduction layer 120 is a fabric wrapped cotton layer, consistency between forms in positions on the conduction layer 120 can be ensured, thereby ensuring that an atomization state of an aerosol generation device with the heating element 100 is controllable. In addition, compared with the related technologies in which the conduction layer 120 is a ring-shaped sponge cotton layer, the conduction layer 120 formed with the braiding method has small compressibility, so that a part of the conduction layer 120 around which the heating wire 130 is wound is slightly different from a part around which the heating wire 130 is not wound in thickness, and the conduction layer 120 has very good consistency, to ensure the taste of the aerosol generation device.

In addition, the conduction layer 120 is arranged into an integrally braided structure, that is, the conduction layer 120 is formed by using a braiding method on the outer side of the support tube 110, the conduction layer 120 and the support tube 110 can further closely fit each other, thereby ensuring that a gap between the conduction layer 120 and the support tube 110 is controllable, to facilitate sealing, and liquid leakage can be further prevented.

In actual application, yarn may be braided to form the conduction layer 120 by using a braiding machine, that is, the conduction layer 120 is a cotton layer, that is, the heating element 100 is a cotton core heating element, so that the aerosol generation device can have a higher atomization amount while ensuring that the cotton layer has very good integrity and consistency.

It is worth noting that the heating element 100 further includes a heating wire 130, and the heating wire 130 is spirally wound around the outer side of the conduction layer 120. After the support tube 110 is wrapped in the conduction layer 120 by using the braiding machine, the heating wire 130 may be wound around the outer side of the conduction layer 120 by using a winding machine, and therefore consistency between positions on the conduction layer 120 can be further ensured. Specifically, in each of the related technologies, when the heating wire 130 is wound, manual mounting is used. Consequently, assembly between the heating wire 130 and the conduction layer 120 has poor consistency, and assembly efficiency is low. The winding the heating wire 130 around the outer side of the conduction layer 120 through the winding machine can effectively overcome the problem of poor consistency caused because of manually mounting the heating wire 130, and improve product assembly efficiency, so that tastes of different aerosol generation devices have very good consistency.

In specific application, the braiding texture of the integrally braided structure may be set according to actual needs.

It should be noted that the material for braiding the conduction layer 120 may be a fiber material such as cotton thread, cotton yarn, flax, viscose, polyester, or polyimide, and may be specifically set according to actual needs. It can be understood that the performing braiding with the cotton thread or the cotton yarn to form the conduction layer 120 can increase the atomization amount of the aerosol generation device while enabling the conduction layer 120 to have very good integrity and consistency.

In a specific embodiment, further, the thickness d of the conduction layer 120 satisfies 0.1 mm≤d≤3 mm.

In this embodiment, the thickness d of the conduction layer 120 is limited to satisfying 0.1 mm≤d≤3 mm. It can be understood that the thickness of the conduction layer 120 should not be excessively large, and if the thickness of the conduction layer 120 is excessively large, circulation of the aerosol generation substrate is not facilitated. In addition, the compressibility of the conduction layer 120 is further improved. When the heating wire 130 is wound, consistency between positions on the conduction layer 120 is prone to be poor. In addition, the thickness of the conduction layer 120 should not be excessively small, and if the thickness of the conduction layer 120 is excessively small, the atomization amount of the aerosol generation device is affected. The limiting the thickness of the conduction layer 120 to ranging from 0.1 mm to 3 mm can ensure the atomization amount of the aerosol generation device while enabling positions on the conduction layer 120 to have very good consistency.

### Embodiment 2

As shown in FIG. 1, FIG. 2, FIG. 5, FIG. 6, and FIG. 7, based on any one of the foregoing embodiments, further, the conduction layer 120 includes cotton thread or cotton yarn, and the conduction layer 120 is formed into the integrally braided structure by the cotton thread or the cotton yarn with a braiding method.

In this embodiment, the conduction layer 120 is limited to including cotton thread or cotton yarn. That is to say, cotton thread is used for preparing the conduction layer 120 using the braiding method, thereby forming the conduction layer 120 into the integrally braided structure. To be specific, the conduction layer 120 is a cotton layer, that is, the heating element 100 is a cotton core heating element, thereby increasing the atomization amount of the aerosol generation device while ensuring that the cotton layer has very good integrity and consistency.

In addition, cotton yarn may alternatively be used for preparing the conduction layer 120 using the braiding method, so that the obtained conduction layer 120 is formed into the integrally braided structure, and may be specifically set according to actual needs.

In actual application, cotton thread or cotton yarn may be braided using the braiding machine to wrap the outer side of the support tube 110. It can be understood that the density and the thickness of the conduction layer 120 may be controlled by adjusting the braiding speed of the braiding machine. Specifically, the braiding texture may be diagonal texture, cross texture, or herringbone texture, and may be specifically set according to actual needs.
based on the foregoing embodiments, further, the cotton thread or the cotton yarn includes 8 strands to 64 strands of yarn.

In this embodiment, the cotton thread or the cotton yarn is limited to including 8 strands to 64 strands of yarn. That is to say, 8 strands to 64 strands of yarn are braided using the braiding machine to form the conduction layer 120, thereby forming the conduction layer 120 into the integrally braided structure. To be specific, the conduction layer 120 is a cotton layer, that is, the heating element 100 is a cotton core heating element, thereby increasing the atomization amount of the aerosol generation device while ensuring that the cotton layer has very good integrity and consistency.

In addition, that the cotton thread or the cotton yarn includes 8 strands to 64 strands of yarn can ensure that the conduction layer 120 formed through braiding has specified thickness and circulation performance.

In actual application, the yarn may be a single strand of yarn, or be formed by merging 2 strands to 8 strands of second-level yarn, and may be specifically set according to actual needs.
based on the foregoing embodiments, further, the yarn is a single strand of first-level yarn; or the yarn includes 2 strands to 8 strands of second-level yarn.

In this embodiment, the yarn may be limited to being a single strand of first-level yarn, that is, 8 strands to 64 strands of first-level yarn are braided using the braiding machine to form the conduction layer 120, thereby forming the conduction layer 120 into the integrally braided structure. Alternatively, the yarn may be formed by merging 2 strands to 8 strands of second-level yarn, and then 8 strands to 64 strands of second-level yarn formed through merging are braided using the braiding machine to form the conduction layer 120, thereby forming the conduction layer 120 into the integrally braided structure, thereby increasing the atomization amount of the aerosol generation device while ensuring that the cotton layer has very good integrity and consistency.

In actual application, the material of the yarn may be twist yarn or twistless yarn made of filament or staple, and may be specifically set according to actual needs.

In a specific embodiment, further, the diameter D of the yarn satisfies 0.05 mm≤D≤2 mm.

In this embodiment, the value range of the diameter D of the yarn is limited. To be specific, the value range of the diameter of each strand of first-level yarn or each strand of merged second-level yarn is limited. It can be understood that if the diameter of the yarn is excessively small, the conduction layer 120 formed through braiding has low structural strength, and the service life of the heating element 100 is shortened. If the diameter of the yarn is excessively large, the conduction layer 120 formed through braiding is prone to be excessively thick, which is adverse to the circulation of the aerosol generation substrate and affects the atomization amount of the aerosol generation device. The limiting the diameter of the yarn to ranging from 0.05 mm to 2 mm can increase the atomization amount of the aerosol generation device while ensuring that the conduction layer 120 has specific structural strength.

In another specific embodiment, further, the fineness S of the yarn satisfies 10≤S≤60.

In this embodiment, it can be understood that the larger fineness of the yarn indicates the smaller diameter of the yarn, and the further limiting the value range of the fineness of the yarn can further increase the atomization amount of the aerosol generation device while ensuring that the conduction layer 120 has specific structural strength.

### Embodiment 3

As shown in FIG. 1 and FIG. 3, based on any one of the foregoing embodiments, further, the heating element 100 further includes a heating wire 130. The heating wire 130 is wound around an outer side of the conduction layer 120, and the heating wire 130 includes a plurality of winding portions, where a spacing is provided between the plurality of winding portions and the conduction layer 120; or the plurality of winding portions are in contact with the conduction layer 120.

In this embodiment, the heating element 100 is limited to further including a heating wire 130. Specifically, the heating wire 130 is wound around an outer side of the conduction layer 120. Specifically, the heating wire 130 is spirally wound around the outer side of the conduction layer 120, so that when the heating wire 130 is electrified to generate heat, the aerosol generation substrate flowing toward the conduction layer 120 can be heated and atomized, to generate an aerosol.

Further, the heating wire 130 includes a plurality of winding portions, where a spacing is provided between the plurality of winding portions and the conduction layer 120, or the plurality of winding portions are in contact with the conduction layer 120. That is to say, when the heating wire 130 is wound around the outer side of the conduction layer 120, the conduction layer 120 may not be compressed, so that a part of the conduction layer 120 around which the heating wire 130 is wound is consistent with a part around which the heating wire 130 is not wound in thickness, thereby further ensuring consistency of the conduction layer 120, and then ensuring that the atomization state of the aerosol generation device is controllable.

In actual application, the heating wire 130 may be wound around the outer side of the conduction layer 120 using the winding machine, thereby further ensuring consistency between positions on the conduction layer 120. Specifically, in each of the related technologies, when the heating wire 130 is wound, manual mounting is used. Consequently, assembly between the heating wire 130 and the conduction layer 120 has poor consistency, and assembly efficiency is low. The winding the heating wire 130 around the outer side of the conduction layer 120 through the winding machine can effectively overcome the problem of poor consistency caused because of manually mounting the heating wire 130, and improve product assembly efficiency, so that tastes of different aerosol generation devices have very good consistency.

### Embodiment 4

As shown in FIG. 1 and FIG. 4, based on any one of the foregoing embodiments, further, the support tube 110 includes a body 111 and a plurality of through-holes 112, where the body 111 is provided with a conduction cavity, the plurality of through-holes 112 are arranged on the body 111, and the plurality of through-holes 112 are in communication with the conduction cavity and the conduction layer 120.

In this embodiment, the support tube 110 is limited to including a body 111 and a plurality of through-holes 112. Specifically, the body 111 is provided with a conduction cavity, it can be understood that the aerosol generation substrate can be fed into the conduction cavity and flow toward the conduction layer 120 through the plurality of through-holes 112 on the body 111, and a heating wire 130 of the heating element 100 heats and atomizes the aerosol generation substrate flowing toward the conduction layer 120, to generate an aerosol.

In actual application, the material of the support tube 110 includes one of a metal material, a ceramic material, glass, or engineering plastic, thereby ensuring the structural strength of the support tube 110, and therefore the conduction layer 120 can be effectively supported.

It is worth noting that the through-hole 112 may be a circular hole or an elliptical hole, and may be specifically set according to actual needs. In addition, the quantity of through-holes 112 may also be set according to actual needs or the specific size of the aerosol generation device.

In a specific embodiment, further, the inner diameter a of the body 111 satisfies 0.3 mm≤a≤3 mm.

In this embodiment, the value range of the inner diameter of the body 111 is limited, that is, the value range of the width of the conduction cavity is limited. It can be understood that if the inner diameter of the body 111 is excessively small, that is, the width of the conduction cavity is excessively small, the amount of the aerosol generation substrate fed per unit volume is small, and the atomization amount of the aerosol generation device is reduced. If the inner diameter of the body 111 is excessively large, the volume of the heating element 100 is large, which occupies the internal space of the aerosol generation device in an aspect and further causes the volume of the aerosol generation device to be large in another aspect and is adverse to the aesthetics of the product. The limiting the inner diameter of the body 111 to ranging from 0.3 mm to 3 mm can improve the aesthetics of the product while ensuring the atomization amount of the aerosol generation device.

In another specific embodiment, further, the axial length b of the body 111 satisfies 3 mm≤b≤30 mm.

In this embodiment, the value range of the axial length of the body 111 is limited. Specifically, the axial length b of the body 111 satisfies 3 mm≤b≤30 mm. The value range can improve the aesthetics of the product while ensuring the atomization amount of the aerosol generation device, and may be specifically set according to the size of the product of the aerosol generation device.

In still another specific embodiment, further, the hole diameter n of the through-hole 112 satisfies 0.01 mm≤n≤3 mm.

In this embodiment, the value range of the hole diameter of the through-hole 112 is limited. Specifically, the hole diameter n of the through-hole 112 satisfies 0.01 mm≤n≤3 mm. It can be understood that if the hole diameter of the through-hole 112 is excessively small, the circulation of the aerosol generation substrate is not facilitated, and the atomization amount of the aerosol generation device is reduced. If the hole diameter of the through-hole 112 is excessively large, the structural strength of the support tube 110 is reduced, and therefore the service life of the heating element 100 is shortened. The limiting the hole diameter of the through-hole 112 to ranging from 0.01 mm to 3 mm can prolong the service life of the heating element 100 while ensuring the atomization amount of the aerosol generation device.

In actual application, the conduction layer 120 includes a plurality of capillary holes, and the hole diameter of the through-hole 112 is less than the inner diameter of the body 111 and greater than the diameter of the capillary hole of the conduction layer 120, thereby ensuring effective circulation of the aerosol generation substrate, and then ensuring the atomization amount of the aerosol generation device.
based on the foregoing embodiments, further, the material of the support tube 110 includes one of a metal material, a ceramic material, glass, or engineering plastic.

In this embodiment, the material of the support tube 110 is limited to including one of a metal material, a ceramic material, glass, or engineering plastic, thereby ensuring the structural strength of the support tube 110, and therefore the conduction layer 120 can be effectively supported.

### Embodiment 5

According to a second aspect of this application, an aerosol generation device 200 is provided. The aerosol generation device 200 includes the heating element 100 provided in any one of the foregoing embodiments, and therefore has all beneficial technical effects of the heating element 100. Details are not described herein again.

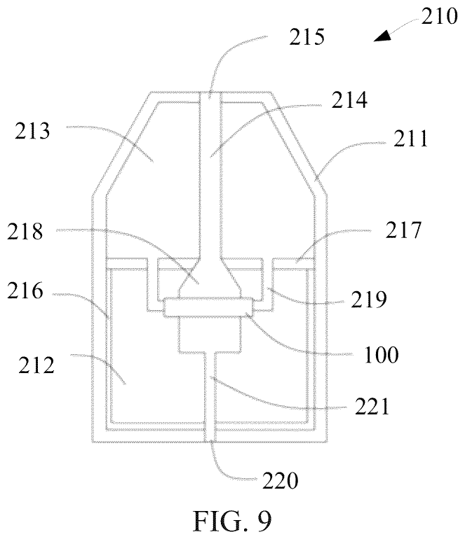

As shown in FIG. 8 and FIG. 9, based on the foregoing embodiments, further, the aerosol generation device 200 further includes an accommodating cavity 210, an aerosol generation substrate, and a power supply device 230. The aerosol generation substrate is located in the accommodating cavity 210, and the power supply device 230 is connected to the accommodating cavity 210 and electrically connected to a heating wire 130 of the heating element 100.

In this embodiment, the aerosol generation device 200 is limited to further including an accommodating cavity 210, an aerosol generation substrate, and a power supply device 230. Specifically, the accommodating cavity 210 is used for accommodating the aerosol generation substrate, and the aerosol generation substrate can be fed into a support tube 110 and flow toward a conduction layer 120 through a plurality of through-holes 112 on the support tube 110. The power supply device 230 supplies power for the heating wire 130, so that the heating wire 130 generates heat, and the heat generated by the heating wire 130 can heat and atomize the aerosol generation substrate, to generate an aerosol. The aerosol generation substrate is a liquid aerosol generation substrate.

Further, the conduction layer 120 is of an integrally braided structure. That is to say, the conduction layer 120 is manufactured into a braided structure by a conduction substrate with a braiding method, thereby enabling the conduction layer 120 to have very good integrity and consistency. Compared with the related technologies in which the conduction layer 120 is a fabric wrapped cotton layer, consistency between forms in positions on the conduction layer 120 can be ensured, thereby ensuring that an atomization state of an aerosol generation device with the heating element 100 is controllable. In addition, compared with the related technologies in which the conduction layer 120 is a ring-shaped sponge cotton layer, the conduction layer 120 formed with the braiding method has small compressibility, so that a part of the conduction layer 120 around which the heating wire 130 is wound is slightly different from a part around which the heating wire 130 is not wound in thickness, and the conduction layer 120 has very good consistency, to ensure the taste of the aerosol generation device.

### Embodiment 6

As shown in FIG. 9, In a specific embodiment, further, an accommodating cavity 210 includes a housing 211. A liquid storage cavity 213 and an air outlet channel 214 are provided in the housing 211. The liquid storage cavity 213 is used for storing a liquid aerosol generation substrate, and the liquid storage cavity 213 is provided around the air outlet channel 214. An inhalation opening 215 is further provided on an end portion of the housing 211, and the inhalation opening 215 is in communication with the air outlet channel 214.

The accommodating cavity further includes a sealing member 217 and an atomization base 212. The sealing member 217 divides the housing 211 into the liquid storage cavity 213 and a holding cavity 216, the liquid storage cavity 213 is located above the holding cavity 216, the atomization base 212 is located in the holding cavity 216, a receiving cavity 218 is provided on the atomization base 212, the receiving cavity 218 is in communication with the air outlet channel 214, and a heating element 100 is mounted on the atomization base 212 and located in the receiving cavity 218. A liquid flowing channel 219 connecting the liquid storage cavity 213 to the heating element 100 is further provided on the atomization base 212, the aerosol generation substrate in the liquid storage cavity 213 enters a conduction layer 120 of the heating element 100 through the liquid flowing channel 219, and a heating wire 130 heats and atomizes the aerosol generation substrate.

An air inlet 220 and an air inlet channel 221 are further provided on the housing 211, and the air inlet channel 221 is in communication with the air inlet 220 and the receiving cavity 218 separately.

In the description of this specification, terms such as “connection”, “mounting”, and “fixation” should all be understood in a broad sense. For example, “connection” may be a fixed connection, a detachable connection, or an integral connection; or the connection may be a direct connection, or an indirect connection by using an intermediary. A person of ordinary skill in the art may understand the specific meanings of the foregoing terms in this application according to specific situations.

In the descriptions of this specification, a description of a term such as “an embodiment”, “some embodiments”, or “a specific example” means that a specific feature, structure, material, or characteristic that is described with reference to the embodiment or the example is included in at least one embodiment or example of this application. In this specification, exemplary descriptions of the foregoing terms do not necessarily refer to the same embodiment or example. In addition, the described specific feature, structure, material, or characteristic may be combined in a proper manner in any one or more embodiments or examples.

The above descriptions are merely preferred embodiments of this application and are not intended to limit this application. For a person skilled in the art, this application may have various modifications and changes. Any modification, equivalent replacement, or improvement made without departing from the spirit and principle of this application shall fall within the protection scope of this application.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A. B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating element for heating and atomizing an aerosol generation substrate, comprising:
a support tube; and
a conduction layer arranged on an outer side of the support tube and in communication with the support tube, the conduction layer comprising an integrally braided structure.

2. The heating element of claim 1, wherein a thickness of the conduction layer is greater than or equal to 0.1 mm and less than or equal to 3 mm.

3. The heating element of claim 1, wherein the conduction layer comprises cotton thread or cotton yarn, and
wherein the conduction layer is formed into the integrally braided structure by the cotton thread or the cotton yarn with a braiding method.

4. The heating element of claim 3, wherein the cotton thread or the cotton yarn comprises 8 strands to 64 strands of yarn.

5. The heating element of claim 4, wherein the yarn comprises a single strand of first-level yarn, or
wherein the yarn comprises 2 strands to 8 strands of second-level yarn.

6. The heating element of claim 4, wherein a diameter of the yarn is greater than or equal to 0.05 mm and less than or equal to 2 mm.

7. The heating element of claim 4, wherein a fineness of the yarn is greater than or equal to 10 and less than or equal to 60.

8. The heating element of claim 1, further comprising:
a heating wire wound around an outer side of the conduction layer, the heating wire comprising a plurality of winding portions,
wherein a spacing is provided between the plurality of winding portions and the conduction layer, or the plurality of winding portions are in contact with the conduction layer.

9. The heating element of claim 1, wherein the support tube comprises:
a body provided with a conduction cavity; and
a plurality of through-holes arranged on the body, the plurality of through-holes being in communication with the conduction cavity and the conduction layer.

10. The heating element of claim 9, wherein the inner diameter of the body greater than or equal to 0.3 mm and less than or equal to 3 mm.

11. The heating element of claim 9, wherein an axial length of the body greater than or equal to 3 mm and less than or equal to 30 mm.

12. The heating element of claim 9, wherein a hole diameter of the through-hole greater than or equal to 0.01 mm and less than or equal to 3 mm.

13. The heating element of claim 1, wherein a material of the support tube comprises at least one of a metal material, a ceramic material, glass, or engineering plastic.

14. An aerosol generation device, comprising:
the heating element of claim 1.

15. The aerosol generation device of claim 14, further comprising:
an accommodating cavity;
an aerosol generation substrate located in the accommodating cavity; and
a power supply device connected to the accommodating cavity and electrically connected to a heating wire of the heating element.
